(19) United States
(12) Patent Application Publication
(10) Pub. No.: US 2021/0262765 A1
(43) Pub. Date: Aug. 26, 2021

(54) HIT PERFORMANCE WHILE APPROACHING A TARGET

(71) Applicant: MBDA Deutschland GmbH, Schrobenhausen (DE)

(72) Inventor: Wolfgang SCHLOSSER, Gräfelfing (DE)

(73) Assignee: MBDA Deutschland GmbH, Schrobenhausen (DE)

(21) Appl. No.: 17/183,821

(22) Filed: Feb. 24, 2021

(30) Foreign Application Priority Data
Feb. 25, 2020 (DE) 102020001234.5

(51) Int. Cl. F41G 7/22; F41G 7/34

(52) U.S. Cl. CPC F41G 7/2293; F41G 7/343; F41G 7/2253; F41G 7/2226

(57) ABSTRACT

The present invention relates to a computer-implemented method for targeting missiles, to a corresponding computer program, to a corresponding computer-readable medium and to a corresponding data processing device, as well as to a missile.

The present invention relates to a computer-implemented method for (image-based) targeting or flight guidance of missiles, to a corresponding computer program, to a corresponding computer-readable medium and to a corresponding data processing device, as well as to a missile.

The present invention is based on the Lucas-Kanade method (cf. Bruce D. Lucas, Takeo Kanade, “An iterative Image Registration Technique with an Application to Stereo Vision”, Proceedings of Imaging Understanding Workshop, pp. 121-130 (1981)). This is mainly used to estimate translational movements between two images, but it can also, in essence, estimate a complete affine 2D transformation (translation, rotation, X/Y scaling, shear) between images.

A missile can be launched with the aim of reaching a target. In particular, for example, a missile, such as an aircraft, that is intended to reach a specified target area can take off or be launched. A missile such as a guided missile can also be fired in order to hit a target.

So that the missile (e.g.: aircraft, guided missile, etc.) reaches the selected target, a target point of aim is sighted. During or shortly before the missile is fired or takes off, the target range is usually determined by a laser range measurement or a comparable technique. The current target range can be “counted down” over the course of the flight using inertial measurements. However, due to both external influences (e.g. wind) and target movements, this inertial measurement becomes increasingly imprecise as the selected target is approached.

The missile approaches its target at high speed (e.g. 300 km/h [kilometres per hour] or more). A camera built into the missile delivers images of the target, the signature of the target increasing steadily and, towards the end, massively from image to image. With this image enlargement and the simultaneous signature change, an automated target tracking means (tracker) often has difficulty keeping the defined target point of aim on the target with sufficient accuracy. Moreover, the range estimation via the inertial measurement cannot detect the target's own movements, so that the current target range estimated from the inertial measurement does not match the true current target range and thus the true size of the target image does not match its expected size. In particular shortly before the target is reached, i.e. when the true current target range is short (e.g. approximately 100 m [metres]), the automated target tracking means can no longer steer the missile to the target point of aim sufficiently quickly and precisely enough based on the image data from the camera.

DE 102011016521 A1 discloses a flight guidance method of an aircraft for guiding the aircraft to a target object specified by means of image information and in particular to an object on the ground and/or a vicinity of a specified target point on the ground. A model projection (PM-B) of a specified reference model (RM) of the target object or a part of the target object or the vicinity of the specified target point is carried out, in which a projection of the reference model or part thereof onto an image plane is generated on the basis of the current viewing direction of the aircraft, which projection corresponds to a permissible deviation of the image plane on which the detection of the target object or the vicinity by an image sensor of the aircraft is based. For this purpose, information on the current viewing direction of the aircraft from a navigation module or an interface module of the flight guidance system or a filter module is used, in particular as the result of an estimation method from an earlier iteration of the flight guidance method. Furthermore, a texture correlation (T3-TK1) is performed between the image information of a current or quasi-current image (B1) of a time sequence of captured images (B1, B2, B3) of the target object or the vicinity and the projection information determined in the model projection (PM-B) as well as a determination of an estimated current aircraft-target object relative position. Furthermore, a texture correlation (T3-TK2) with image information of a current image and image information for an image (B2) which is considered to be earlier in time than the current image (B3) is performed, in each case from the time sequence of captured images (B1, B2, B3), and an estimated actual direction of movement and/or actual speed of the aircraft is determined. In addition, an estimation method (F-Ges) is carried out for estimating information about the current aircraft-target object relative position of the aircraft relative to the position of the target object and/or a direction of movement and/or an actual speed vector of the aircraft, and the aircraft-target object relative position and/or the actual speed vector is transmitted to a guidance module (LM). Finally, control commands to actuators for actuating aerodynamic control means of the aircraft are generated in the guidance module (LM) on the basis of the determined aircraft-target object relative position and the determined actual speed vector in order to guide the aircraft to the target object.

Against this background, the object of the present invention is that of achieving higher precision or hit performance for image-based flight guidance of a missile to a target to be reached, in particular even when the true current target distance of the missile from the target to be reached is short.

According to the invention, this object is achieved by a computer-implemented method for (image-based) targeting or flight guidance of missiles, the method having the features of claim 1, and by a corresponding computer program, a corresponding computer-readable medium, a corresponding data processing device and a missile having the features of the additional independent claims.

Accordingly, a computer-implemented method for (image-based) targeting or flight guidance of missiles is provided. The computer-implemented method comprises the following steps:
a) receiving, once and prior to the departure of a missile, a template T including a target point of aim;
b) repeatedly receiving, during the flight of the missile and at a predefined image cycle rate f_{B}, image data I from a camera of the missile and inertial range estimations D^{IM}ₙₑᵤ from an inertial measurement;
c) per image cycle of the predefined image cycle rate f_{B}, calculating a pre-scaled starting parameter vector p* for this image cycle using a last calculated range correction ΔD;
d) per image cycle of the predefined image cycle rate f_{B}, carrying out an iterative Lucas-Kanade method in order to calculate an estimated parameter vector p, including a current scale sₙₑᵤ based on the current image data I and on the template T, from the calculated pre-scaled starting parameter vector p* by means of mapping Wₚ, wherein the target point of aim is improved by means of the mapping Wₚ using the estimated parameter vector p;
f) per image cycle of the predefined image cycle rate f_{B}, calculating a range correction ΔD for the next image cycle from a current scale sₙₑᵤ, a previous scale sₐₗₜ, a current inertial range estimation D^{IM}ₙₑᵤ and a previous inertial range estimation D^{IM}ₐₗₜ; and
h) per image cycle of the predefined image cycle rate f_{B}, controlling the missile in a closed-loop manner in order to target the missile based on the improved target point of aim.

A computer program is also provided which comprises instructions which, when the program is executed by a computer, cause the computer to carry out the steps of the computer-implemented method for (image-based) targeting or flight guidance of missiles.

Furthermore, a computer-readable medium is provided on which the computer program is stored.

In addition, a data processing device is provided which comprises means for executing the computer-implemented method for (image-based) targeting or flight guidance of missiles.

A missile is also provided which comprises a camera and the data processing device. The camera is communicatively connected to the data processing device and is designed to repeatedly send image data I to the data processing device at the predefined image cycle rate f_{B}.

In step a), the template T is received. In addition to the template T, the target point of aim to which the missile is to be steered is also received in order for the missile to reach the corresponding target as precisely as possible. The target to be hit is described by the template or a signature, i.e. an image section from at least one image of a target area, on which image the target to be reached is at least partially or completely mapped. The image of the target area can be recorded by at least one camera, in particular by an IR camera of the missile or a separate (IR) camera, and transmitted to a monitoring system. The template may have been selected or “cut out” automatically or by a user (“manually”) in the image of the target area. For example, on a screen on which the image of the target area is displayed by the monitoring system, the user can select the template of the target to be reached by “cutting out” the target to be reached from the image of the target area using a cursor that he controls via an input apparatus (e.g. a mouse, a touch screen, etc.).

In step b), the image data I from the (IR) camera of the missile are repeatedly or continuously received at the predefined image cycle rate f_{B}. The (IR) camera of the missile accordingly sends the image data I at the predefined image cycle rate f_{B}. The (IR) camera of the missile records, at the predefined image cycle rate, images of the target area in which the target to be reached is located. The target area having the target to be reached is accordingly mapped or marked on the recorded images. In addition, at the predefined image cycle rate f_{B}, inertial range estimations are continuously received as the current inertial range estimation D^{IM}ₙₑᵤ or D^{IM}t (inertial range estimation at the current point in time or image cycle t). The inertial range estimations D^{IM} or the changes in the inertial range estimations ΔD^{IM} are based on the known speed v of the missile (for example 300 km/h) and the elapsed time Δt.

ΔD^{IM}=vΔt

If, for example, the missile is flown at the known speed of, for example, v=360 km/h (100 m/s [metres per second]) for Δt=0.02 s [seconds] towards the target to be reached, then the range (when the target to be reached is static) is reduced by 2 m [metres] during this time. The predefined image cycle rate can be 50 Hz [Hertz], for example f_{B}=50 Hz.

In step c), the pre-scaled starting parameter vector p* for the Lucas-Kanade method of this image cycle (step d)) is calculated in each image cycle of the predefined image cycle rate f_{B}. For this purpose, the previously calculated parameter vector pₐₗₜ or pₜ₋ₖ, where k is equal to one or more image cycles, is adjusted based on the last calculated range correction ΔD by correcting or pre-scaling the scale s of the previous calculated parameter vector pₐₗₜ using the last calculated range correction ΔD.

In step d), the received template T of the target to be reached is tracked from image to image, i.e. in every image cycle, by means of the automated target tracking means (tracker) of the Lucas-Kanade type (Lucas-Kanade method). The “four-parametric” parameter vector p is sufficient for this. The four-parametric parameter vector p comprises the following four parameters:
translation in the X direction Δxₕ;
translation in the Y direction Δxᵥ;
rotation/angle of rotation α; and
scale s (zoom factor).

$$p = ( \begin{matrix}Δ {x}_{h} \\ Δ {x}_{v} \\ α \\ s\end{matrix} )$$

The automated target tracking means (tracker) of the Lucas-Kanade type or the Lucas-Kanade method, which is used in the present case, is described in “An iterative Image Registration Technique with an Application to Stereo Vision” by Bruce D. Lucas, Takeo Kanade, Proceedings of Imaging Understanding Workshop, pp. 121-130 (1981).

In the Lucas-Kanade method, the parameter vector p is iteratively estimated or improved until a termination criterion is met. The termination criterion can be, for example, a predefined minimum error reduction Δₘᵢₙ for the functional E(p) (see below),

$$Δ {E}_{min} = \frac{( {E}_{n - 1} ( p ) - {E}_{n} ( p )}{{E}_{n - 1} ( p )} ,$$

or a predefined minimum change Δpₘᵢₙ of the parameter vector p per iteration and, additionally or alternatively, a maximum time period Tₘₐₓ for the Lucas-Kanade method. In particular, it may be predefined that the Lucas-Kanade method must be completed in step d) before the start of the new image cycle or within the current image cycle Tₘₐₓ≤1/f_{B}. For example, for an image cycle rate f_{B} of 50 Hz, the maximum time period Tₘₐₓ can be 0.018 s, f_{B}=50 Hz→Tₘₐₓ=0.018 s≤1/f_{B}.

For target tracking in missiles, the Lucas-Kanade method is used to measure, as precisely as possible from image to image, the specified target point of aim of the target to be reached. In each image cycle of the predefined image cycle rate f_{B}, the target point of aim is improved by means of the mapping Wₚ using the (iteratively) estimated parameter vector p, by searching for the template T in the current image data I of the current image cycle and, based on this, iteratively estimating the parameter vector p. The point of aim can usually be selected in the centre of the template T. The point of aim is mapped onto the current image/the current image data I via the mapping/the warp Wₚ according to the particular estimation of the parameter vector p. A difference with respect to a control point can be determined there and the missiles can be navigated or controlled on the basis of this difference (step h)).

Using the Lucas-Kanade method, the four-parametric parameter vector p is iteratively estimated or changed until the mapping Wₚ, also called “warp”, transfers/maps the points x of the template T as precisely as possible to the corresponding points in the current image data I or in the corresponding current image.

Wₚ=sR(α)+h

Wₚ=f(p)

where R(α) is a rotation matrix for rotation α and h is a translational movement (translation) in the horizontal direction xi, and in the vertical direction xᵥ, with

$$h = ( \begin{matrix}Δ {x}_{h} \\ Δ {x}_{v}\end{matrix} ) .$$

The functional E(p) is to be minimised, with x passing through all image points of the template T.

E(p)=Σₓ|I(Wₚ(x)−T(x))|²

Since the changes between two successive images or successive image data I of a video sequence are only small, the optimisation problem can be solved iteratively using a Taylor series and a compensation calculation over all image points by means of a simple Gauss-Newton or Newton-Raphson descent method. Each iteration of the Lucas-Kanade method thus supplies the change Δp in the parameter vector p by means of which the value of the functional E(p) is reduced. The iteration continues until the termination criterion mentioned above (minimum error reduction ΔEₘᵢₙ and/or minimum change Δpₘᵢₙ and/or maximum time period Tₘₐₓ) is met.

The starting point of the method for the second image/the second image data I (for example the template T can be “punched out” from the first image) is the parameter vector p₀.

$${p}_{0} = ( \begin{matrix}{x}_{TL , h} \\ {x}_{TL , v} \\ 0 \\ 1\end{matrix} )$$

The initial translation ho can correspond, for example, to the upper left corner of the punched out template T, with

$${h}_{0} = ( \begin{matrix}{x}_{TL , h} \\ {x}_{TL , v}\end{matrix} ) .$$

Each new image is the result parameter vector of the last image.

The starting point of the method for all subsequent images/image data I of all subsequent image cycles at the predefined image cycle rate f_{B} is the (final) estimated parameter vector p from the previous image cycle.

In step f), in each image cycle of the predefined image cycle rate f_{B}, the range correction ΔD is calculated for the next image cycle. In order to reduce the number of iterations required in the Lucas-Kanade method (for each image cycle) for a satisfactory optimisation result of the parameter vector p, prior knowledge about the distance to the target, e.g. from an integrated inertial measurement, is applied in advance to the last estimated scale sₐₗₜ or sₜ₋ₖ. The target distances from the inertial measurements D^{IM} are related to the scales s of the Lucas-Kanade method. This happens based on the ratio of the current inertial range estimation D^{IM}ₙₑᵤ or D^{IM}ₜ to the previous inertial range estimation D^{IM}ₐₗₜ or D^{IM}ₜ₋ₖ and the ratio of the current scale sₙₑᵤ or sₜ to the previous scale sₐₗₜ:

$$\frac{{s}_{neu}}{{s}_{a l t}} = \frac{{D}_{alt}}{{D}_{neu}} {=}^{def} \frac{{D}_{a l t}^{I M} + Δ D}{{D}_{neu}^{IM} + Δ D}$$

The current scale sₙₑᵤ is the scale of the parameter vector p calculated in this image cycle in step d). The previous scale sₐₗₜ is the scale of the parameter vector pₐₗₜ or pₜ₋ₖ calculated in the previous image cycle in step d). The current inertial range estimation D^{IM}ₙₑᵤ is the inertial range estimation received in this image cycle. The previous inertial range estimation D^{IM}ₐₗₜ is the inertial range estimation received in the previous image cycle. Dₐₗₜ denotes the previous actual range to the target and Dₙₑᵤ denotes the current actual range to the target.

Based on this, the range correction ΔD is calculated, which precisely corrects the “incorrect” ranges (=inertial measurements) D^{IM} integrated from inertial measurements, as follows:

$$Δ D = \frac{{s}_{n e u} {D}_{n e u}^{IM} - {s}_{a l t} {D}_{a l t}^{IM}}{{s}_{a l t} - {s}_{n e u}}$$

Using the calculated range correction ΔD, the starting parameter vector p* and in particular the scale s of the starting parameter vector p* is pre-scaled in the next image cycle in step c) using the following formula:

$${s}_{neu} = \frac{{D}_{a l t}^{IM} + Δ D}{{D}_{n e u}^{IM} + Δ D} {s}_{a l t}$$

The number of iterations of the Lucas-Kanade method that are necessary to find a sufficiently accurate estimated parameter vector p is thus significantly reduced. Conversely, the reduction in the number of iterations required to meet the termination criterion (see above) in the iterative Lucas-Kanade method means that the termination criterion can be tightened in the allowed computing time (Tₘₐₓ≤1/f_{B}) (e.g. the tolerated residual error can be reduced), which increases the number of iterations required, but improves the quality of the estimation result.

The underlying Lucas-Kanade method (step d)) is an iterative optimisation method in which the (additional) estimation of the scale s requires many iterations and thus computing time. By introducing the known scale change, which is as precisely estimated as possible, into the actual tracking method (Lucas-Kanade method) in the course of the pre-scaling, the number of necessary iterations can be significantly reduced. This exact scale change/pre-scaling in turn requires precise range estimation by calculating the range correction ΔD. The scale s estimated in this way is used to correct the inertial-based range estimation D^{IM} in the subsequent image cycle, which leads to substantial improvements, in particular in the case of moving targets.

In step h), in order to target the missile, in each image cycle of the predefined image cycle rate f_{B}, the missile is controlled in a closed-loop manner based on the improved target point of aim. In particular, a difference with respect to a control point can be determined and the missiles can be navigated or controlled on the basis of this difference. For this purpose, control commands can be transmitted to one or more actuating mechanisms of the missile in order to actuate one or more aerodynamic control means (e.g. flaps on winglets or wings) and, additionally or alternatively, to one or more drives (e.g. jet engine, propeller, etc.) of the missile. The control commands are derived from the estimated parameter vector p.

The computer-readable medium can be a data memory such as a magnetic memory (e.g. magnetic core memory, magnetic tape, magnetic card, magnetic strip, magnetic bubble memory, drum memory, hard disk drive, floppy disk or removable disk), an optical memory (e.g. holographic memory, optical tape, Tesa Film tape, LaserDisc, Phasewriter (Phasewriter Dual, PD), Compact Disc (CD), Digital Video Disc (DVD), High Definition DVD (HD DVD), Blu-ray Disc (BD) or Ultra Density Optical (UDO)), a magneto-optical memory (e.g. MiniDisc or Magneto-Optical Disk (MO-Disk)), a volatile semiconductor memory (e.g. Random Access Memory (RAM), Dynamic RAM (DRAM) or Static RAM (SRAM)), a non-volatile semiconductor memory (e.g. Read Only Memory (ROM), Programmable ROM (PROM), Erasable PROM (EPROM), Electrically EPROM (EEPROM), Flash-EEPROM (e.g. USB stick), Ferroelectric RAM (FRAM), Magnetoresistive RAM (MRAM) or Phase-change RAM) or a data carrier or storage medium.

The data processing device can, for example, include (personal) computers (PC), microcontrollers (μC), integrated circuits, application-specific integrated circuits (ASIC), application-specific standard products (ASSP), digital signal processors (DSP), field-programmable (logic) gate arrays (FPGA) and the like. The data processing device can be communicatively connected (wired, e.g. bus system, or wireless, e.g. radio link) to a control unit of the missile. In particular, the data processing device and the control unit of the missile can be designed as a common device of the missile.

The missile can be, for example, an aircraft that can be controlled automatically, a drone, a guided missile, a guidable projectile and the like.

The camera of the missile can in particular be an IR camera that delivers infrared (IR) images of the target area and of the target or the target point of aim. The camera is communicatively connected to the data processing device (wired, data bus, VGA cable, etc., or wireless, e.g. Bluetooth, Zigbee, etc.). Furthermore, the missile can comprise one or more actuating mechanisms and, additionally or alternatively, one or more drives. The one or more actuating mechanisms can adjust one or more aerodynamic control means of the missile (for example flaps on winglets or on wings). The missile can also include a control unit which is designed to control the one or more actuating mechanisms and, additionally or alternatively, the one or more drives of the missile and thus its flight path. The data processing device transmits the improved target point of aim to the control unit. Based on the improved target point of aim, the control unit controls, using control commands, the the one or more actuating mechanisms and, additionally or alternatively, the one or more drives.

The method according to the invention can be applied both to IR images and to TV images (monochrome/colour). The activation distance, that is to say the distance from the missile to the target, from which the method according to the invention is started, can also be dependent on the spatial resolution of the field of view of the camera of the missile. This is because the better the resolution of the camera, the lower-noise the estimation of the scale s. Optionally, the steps f) and c) and, additionally or alternatively, e) (see below) or the range correction ΔD can be carried out or calculated only from a sufficiently short current target distance (e.g. from approx. 600 m) (=activation distance), since the estimation of the scale s is too noisy beforehand.

The number of required iterations of the Lucas-Kanade method (step d)) can be significantly reduced by calculating the range correction ΔD for the following image cycle in each case and pre-scaling the starting parameter vector p* or in particular the scale s of the starting parameter vector p* based on the particular calculated range correction ΔD. This ensures that even shortly before the target is reached, when the scale changes between the individual image cycles are large, the Lucas-Kanade method nonetheless converges within one image cycle and a sufficiently precise parameter vector p is estimated. This enables exact targeting based on the estimated parameter vector p, even if the range to the target is only short. Accordingly, one concept on which the present invention is based is to design the method for (image-based) targeting or flight guidance of missiles to be more precise by calculating, from the received images, corrections of the estimated range.

Assuming a given maximum computing time Tₘₐₓ of 20 ms (image cycle at a predefined image cycle rate f_{B}=50 Hz), at most 30 iterations are possible, for example. The iteration of the Lucas-Kanade method is terminated, however, if the error reduction ΔEₘᵢₙ for E(p) falls below the value 0.001, i.e. if, for the nth iteration, the following applies:

$$Δ {E}_{min} = \frac{( {E}_{n - 1} ( p ) - {E}_{n} ( p )}{{E}_{n - 1} ( p )} < 0.001$$

In this case, the true scale change between two consecutive images is 1% and the scale change estimation based on the range estimations of the inertial measurement is 0.5%.

Without the pre-scaling of the starting parameter vector p*, 0.5% scale change is taken into account in advance. Thus, in addition to translation and rotation, 0.5% scale errors must also be iteratively taken into account or compensated for. After 30 iterations, the Lucas-Kanade method terminates in this example with an error reduction of 0.002. The method has therefore not quite achieved the desired error factor, but still delivers a usable result.

Using the present invention, an improved scale change of, for example, 0.85% (instead of 0.5%) can be determined in advance by pre-scaling the starting parameter vector p* with the range correction ΔD. Therefore, only 0.15% scale errors have to be iteratively taken into account or compensated for. For this purpose, the desired minimum error reduction ΔEₘᵢₙ of 0.001 is already achieved after 16 iterations. The termination criterion could therefore be reduced, e.g. to ΔEₘᵢₙ=0.0005. Thus, using the (here 14) possible further iterations, the estimation result for the mapping Wₚ or the estimated parameter vector p could be further improved in the same maximum computing time Tₘₐₓ (here 20 ms).

The end result is that the improved estimation of the mapping Wₚ contributes significantly to the stability of the point of aim. In particular on the final approach to the target, the improved pre-scaling allows longer and more precise measurement of the point of aim, since large scale changes and thus considerable errors due to incorrect scale assumptions occur due to the short distance. The scale errors of the inertial-measurement-based range estimation are particularly large when target objects are moving, for two reasons: firstly, time elapses between the range measurement before take-off/launch and the actual take-off/launch, during which time the target is moving; secondly, the movement of the target during the flight is not recorded by the inertial measurement. Assuming, for example, a total time difference of 15 s between the initial range measurement and the theoretical reaching of the target by the missile, a linear movement of the target of 36 km/h in the direction of the missile would make a range difference of 150 m. After 13 s the difference would already be 130 m, which means an overall scale error of 360 m/230 m−1˜56.6% for an assumed target remaining distance of 360 m for a moving target. Viewed image-wise, the error looks like this at this point in time:
assumed movement per image is 360 m/2 s=3.6 m/image cycle
inertial scale estimation (image to image): 360 m/356.4 m−1=1.01%
improved estimation (image to image): 230 m/226.4 m−1=1.59%
The scale to be iteratively estimated without the improved pre-scaling is therefore 0.58%.

Advantageous embodiments and developments can be found in the further dependent claims and from the description with reference to the drawings.

The method may further comprise the following step:
e) per image cycle of the predefined image cycle rate f_{B}, compensating, by means of an offset and optionally a scaling factor for the next image cycle, for differences in brightness between the template T and the image data I scaled using the mapping Wp.

The expression for calculating ΔD (see above) is numerically unstable for very small real scale changes—i.e. for long ranges. Small estimation errors for the scales can therefore provide extremely large corrections. To counter this, the differences in brightness between the template T and the image data I scaled using the mapping Wₚ are compensated for. As a result, the difference image, which is taken into account in the compensation calculation for the geometric mapping parameters of the mapping/warp Wₚ, is kept free from influences of brightness (only the “target structure” is taken into account).

In order to be able to estimate the scale s with sufficient accuracy, a brightness compensation (offset and gain between the template T and the image) is thus integrated into the method. By means of the brightness compensation, using the method according to the invention, the scale change can be estimated even more effectively and the inertial-based range estimation D^{IM} can be considerably improved using the scale change estimated in this way. This increases the hit precision, in particular since tracking can thus take place successfully until shortly before the target=(the Lucas-Kanade method can be carried out in each image cycle until the quality criterion (ΔEₘᵢₙ, Δpₘᵢₙ) is reached).

It can also be provided that the steps f) and c) and/or e) are carried out only if changes in the scale s become significant, in particular when

$$\frac{{s}_{n e u}}{{s}_{a l t}} - 1 > S ,$$

where S is a predefined threshold value.

This also contributes to the numerical stability of the method according to the invention.

Furthermore, the method may further comprise the following step:
g) selecting, in a scale-controlled manner, a section, replacing the template T, in the current image data I as a new template T for the next image cycle.

Step g) can optionally be carried out per image cycle of the predefined image cycle rate f_{B} or in each case after a predefined number of image cycles.

This resampling of the template T, in particular given a sufficiently large total scale s_{ges} of the warp Wₚ, also improves the required computing time and increases the quality of the estimated warp Wₚ or of the estimated parameter vector p. The scale s leads to the observed image points Wₚ(x) being pulled further and further apart, so that the real target in the current image/in the current image data I is scanned more and more roughly; the scanning on the template T is always constantly one image point, while it is s image points on the warped image. “Resampling” by again punching out the vicinity of the point of aim in the new image increases the resolution of the target image and stabilises the entire method. In other words, in order to refine the resolution of the target on the template T, in particular as a function of the scale s, the template T is repeatedly resampled, which subsequently also renders the scale estimation more reliable. During the mentioned resampling by punching out, the four parameters of the parameter vector p have to be correspondingly reset to

$${p}_{0} = ( \begin{matrix}{x}_{TL , h} \\ {x}_{TL , v} \\ 0 \\ 1\end{matrix} )$$

(as at the start of the method, see above).

In addition, the values of the scale buffer (sₐₗₜ) have to be divided by the last calculated scale value s. The method then continues as before.

In step f), an interval of size N can also be considered and averages over a predefined number M of scales s can also be used at the respective interval ends in order to calculate the range correction ΔD.

The method for estimating a range correction considers the development of the scale estimation over a plurality of past images or image data I and determines, from discrete points filtered therefrom, a current correction value for the target range (compared with the inertial range estimation D^{IM}). This correction value is time-filtered again before it is fed back into the tracking process as a final range correction.

In so doing, not only are two successive images/sets of image data I considered, but an interval of N images is considered. In addition, the scales s are also filtered at the interval ends by averaging over M scale values, for example. For M=2*k+1, the correction formula for an image at the point in time t is then, for example:

$$Δ {D}_{t} = \frac{( 1 \text{/} M {\sum }_{i = - k}^{k} {s}_{t - N + k + i} ) * {D}_{t - N + k}^{IM} - ( 1 \text{/} M {\sum }_{i = - k}^{k} {s}_{t - k + i} ) * {D}_{t - k}^{IM}}{{s}_{t - N + k} - {s}_{t - k}}$$

It is also possible for a learning filter to be applied in step f).

The learning filter is built in to further protect the correction value from occasional outliers of individual estimations. For this purpose, the effective correction value at the point in time t is calculated as follows:

ΔD_{eff,t}=(1−α)ΔD_{eff,t-1}+αΔDₜ

where α∈]0,0.5].

The aim of all of the aforementioned measures is to use the correction estimation method as early as possible or as early as is useful in order to reduce the number of iterations of the Lucas-Kanade method as quickly as possible. The specific parameterisation depends largely on the image quality and the image point resolution.

The above configurations and developments can be combined with one another as desired, provided that such a combination is useful. Further possible configurations, developments and implementations of the invention also comprise combinations, not explicitly mentioned, of features of the invention described above or below with regard to the embodiments. In particular, a person skilled in the art will also add individual aspects as improvements or supplements to the particular basic form of the present invention.

The present invention will be described in greater detail below with reference to the embodiments shown in the schematic drawings, in which:

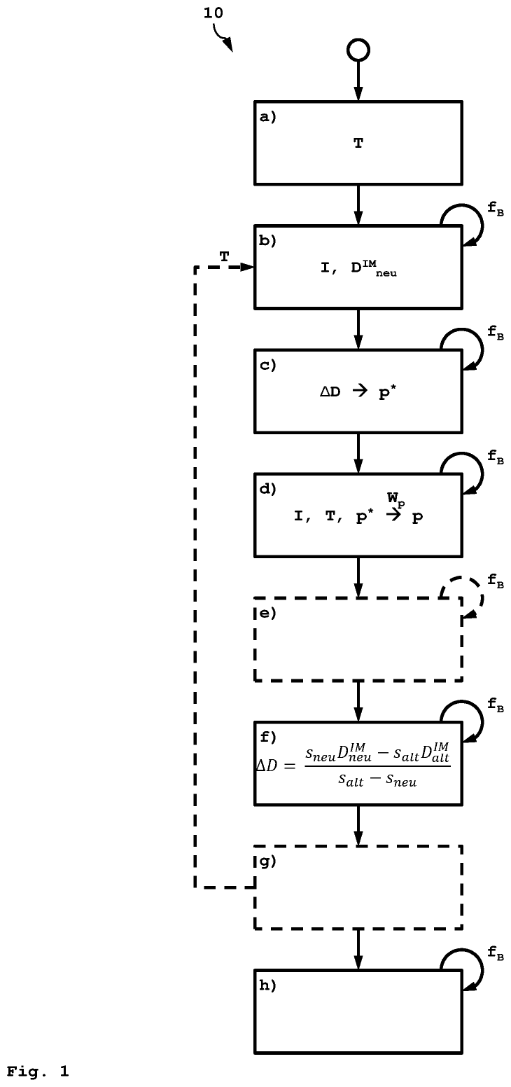

FIG. 1 shows a schematic flow diagram of a computer-implemented method for targeting missiles;

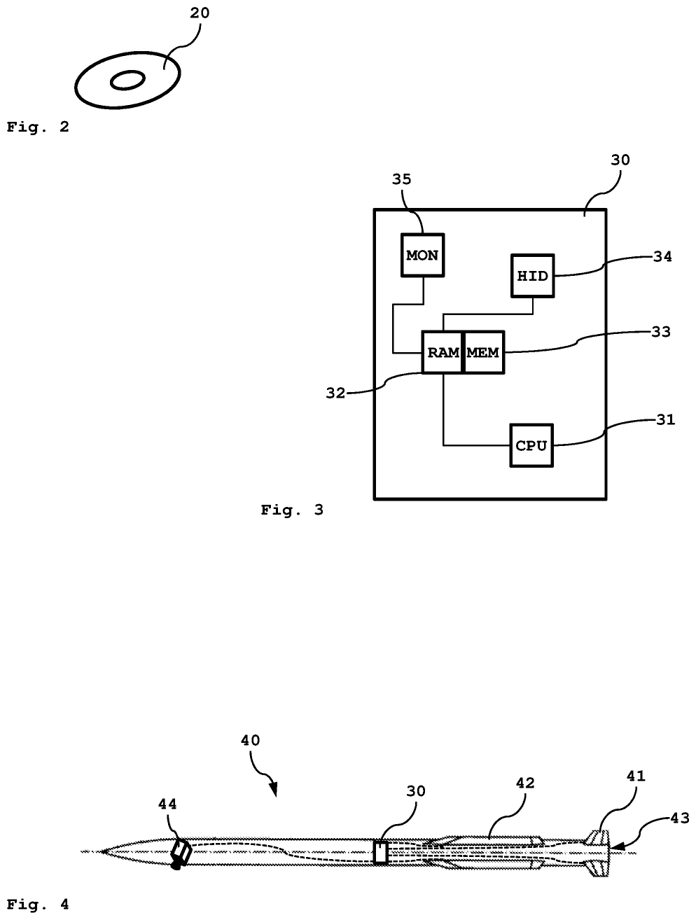

FIG. 2 is a schematic view of a computer-readable medium;

FIG. 3 is a schematic view of a data processing device; and

FIG. 4 is a schematic side view of a missile.

The accompanying figures are intended to provide further understanding of the embodiments of the invention. They illustrate embodiments and, in conjunction with the description, serve to explain principles and concepts of the invention. Other embodiments and many of the advantages mentioned can be seen in the drawings. The elements of the drawings are not necessarily shown to scale with one another.

In the figures of the drawings, identical, functionally identical and identically acting elements, features and components are each provided with the same reference signs, unless stated otherwise.

FIG. 1 shows a schematic flow diagram of a computer-implemented method 10 for targeting missiles. The computer-implemented method 10 comprises the following steps:
a) receiving, once and prior to the departure of a missile, a template T including a target point of aim;
b) repeatedly receiving, during the flight of the missile and at a predefined image cycle rate f_{B}, image data I from a camera of the missile and inertial range estimations D^{IM}ₙₑᵤ from an inertial measurement;
c) per image cycle of the predefined image cycle rate f_{B}, calculating a pre-scaled starting parameter vector p* for this image cycle using a last calculated range correction ΔD;
d) per image cycle of the predefined image cycle rate f_{B}, carrying out an iterative Lucas-Kanade method in order to calculate an estimated parameter vector p, including a current scale sₙₑᵤ based on the current image data I and on the template T, from the calculated pre-scaled starting parameter vector p* by means of mapping Wₚ, wherein the target point of aim is improved by means of the mapping Wₚ using the estimated parameter vector p;
e) per image cycle of the predefined image cycle rate f_{B}, compensating, by means of an offset and optionally a scaling factor for the next image cycle, for differences in brightness between the template T and the image data I scaled using the mapping Wp.
f) per image cycle of the predefined image cycle rate f_{B}, calculating a range correction ΔD for the next image cycle from a current scale sₙₑᵤ, a previous scale sₐₗₜ, a current inertial range estimation D^{IM}ₙₑᵤ and a previous inertial range estimation D^{IM}ₐₗₜ; and
g) selecting, in a scale-controlled manner, a section, replacing the template T, in the current image data I as a new template T for the next image cycle.
h) per image cycle of the predefined image cycle rate f_{B}, controlling the missile in a closed-loop manner in order to target the missile based on the improved target point of aim.

In step a) the template T and the target point of aim to which the missile is to be steered are received. The target to be hit is described by the template (signature), i.e. an image section from at least one image of a target area, on which image the target to be reached is at least partially or completely mapped. The image of the target area was recorded by an IR camera of the missile and transmitted to a monitoring system. The template may have been selected or “cut out” automatically or by a user (“manually”) in the image of the target area (for example, on a screen on which the image of the target area is displayed by the monitoring system, the user can select the template of the target to be reached by “cutting out” the target to be reached from the image of the target area using a cursor that he controls via a mouse). The point of aim is usually selected in the middle of the template T.

In step b), the image data I from the IR camera are repeatedly/continuously received at the predefined image cycle rate f_{B}. The IR camera of the missile accordingly sends, at the predefined image cycle rate f_{B}, the recorded image data I of the target area in which the target to be reached is located. In addition, at the predefined image cycle rate f_{B}, current inertial range estimations D^{IM}ₙₑᵤ or D^{IM}ₜ (inertial range estimation at the current point in time or image cycle t) are continuously received. The inertial range estimations D^{IM} or the changes in the inertial range estimations ΔD^{IM} are based on the known speed v of the missile (for example 300 km/h) and the elapsed time Δt.

ΔD^{IM}=vΔt

In step c), in each image cycle of the predefined image cycle rate f_{B}, the pre-scaled starting parameter vector p* for the Lucas-Kanade method of this image cycle is calculated by adjusting the previously calculated parameter vector pₐₗₜ or pₜ₋ₖ (k equals 1 or more image cycles) by correcting/pre-scaling the scale s of the previously calculated parameter vector pₐₗₜ using the last calculated range correction ΔD.

In step d), the received template T is tracked in each image cycle using the Lucas-Kanade method (automated target tracking means/tracker of the Lucas-Kanade type) with the four-parametric parameter vector p.

$$p = ( \begin{matrix}Δ {x}_{h} \\ Δ {x}_{v} \\ α \\ s\end{matrix} )$$

where Δxₕ is the translation in the X direction, Δxᵥ is the translation in the Y direction, α is the rotation/angle of rotation and s is the scale (zoom factor).

In the Lucas-Kanade method, the parameter vector p is iteratively estimated/improved until a predefined minimum error reduction ΔEₘᵢₙ for the functional E(p) (see below) is met as the termination criterion.

$$Δ {E}_{min} = \frac{( {E}_{n - 1} ( p ) - {E}_{n} ( p )}{{E}_{n - 1} ( p )}$$

The Lucas-Kanade method is used to measure, as precisely as possible from image to image, the specified target point of aim of the target to be reached. In each image cycle of the predefined image cycle rate f_{B}, the target point of aim is improved by means of the mapping Wₚ using the (iteratively) estimated parameter vector p, by searching for the template T in the current image data I of the current image cycle and, based on this, iteratively estimating the parameter vector p. The point of aim is mapped onto the current image data I, i.e. the current image, via the mapping (warp) Wₚ according to the particular estimation of the parameter vector p. A difference with respect to a control point is determined there, and the missile is navigated/controlled on the basis of this difference (step h)). The four-parametric parameter vector p is iteratively estimated/changed until the mapping Wₚ transfers/maps the points x of the template T as precisely as possible to the corresponding points in the current image data I.

Wₚ=sR(α)+h

Wₚ=f(p)

where R(α) is a rotation matrix for rotation α and h is a translational movement (translation) in the horizontal direction xₕ and in the vertical direction xᵥ, with

$$h = ( \begin{matrix}Δ {x}_{h} \\ Δ {x}_{v}\end{matrix} ) .$$

The functional E(p) is to be minimised, with x passing through all image points of the template T.

E(p)=Σₓ|I(Wₚ(x)−T(x))|²

Since the changes between two successive image data I of a video sequence are only small, the optimisation problem is solved iteratively using a Taylor series and a compensation calculation over all image points by means of a simple Gauss-Newton or Newton-Raphson descent method. The iteration continues until the predefined minimum error reduction ΔEₘᵢₙ is met as the termination criterion.

The starting point of the method for the second image data I (the template T is “punched out” from the first image) is the parameter vector p₀.

$${p}_{0} = ( \begin{matrix}{x}_{TL , h} \\ {x}_{TL , v} \\ 0 \\ 1\end{matrix} )$$

The initial translation ho corresponds to the top left corner of the punched out template T, with

$${h}_{0} = ( \begin{matrix}{x}_{TL , h} \\ {x}_{TL , v}\end{matrix} ) .$$

Each new image is the result parameter vector of the last image.

The starting point of the method for all subsequent images/image data I of all subsequent image cycles at the predefined image cycle rate f_{B} is the (final) estimated parameter vector p from the previous image cycle.

In step e), for the next image cycle, brightness differences between the template T and the image data I scaled using the mapping Wₚ are compensated for by means of an offset and a scaling factor (gain). As a result, the difference image, which is taken into account in the compensation calculation for the geometric mapping parameters of the mapping Wₚ, is kept free from influences of brightness (only the “target structure” is taken into account), since the expression for calculating ΔD (see above) is numerically unstable for very small real scale changes (for long ranges) and thus small estimation errors for the scales can lead to extremely large corrections. By means of the brightness compensation, the scale change is estimated even more effectively and the inertial-based range estimation D^{IM} is considerably improved as a result.

In step f), in each image cycle of the predefined image cycle rate f_{B}, the range correction ΔD is calculated for the next image cycle. In order to reduce the number of iterations required in the Lucas-Kanade method for each image cycle, prior knowledge about the distance to the target is applied in advance to the last estimated scale sₐₗₜ or sₜ₋ₖ. The target distances from the inertial measurements D^{IM} are related to the scales s of the Lucas-Kanade method. This happens based on the ratio of the current inertial range estimation D^{IM}ₙₑᵤ or D^{IM}ₜ to the previous inertial range estimation D^{IM}ₐₗₜ or D^{IM}ₜ₋ₖ and the ratio of the current scale sₙₑᵤ or sₜ to the previous scale sₐₗₜ:

$$\frac{{s}_{neu}}{{s}_{a l t}} = \frac{{D}_{alt}}{{D}_{neu}} {=}^{def} \frac{{D}_{a l t}^{I M} + Δ D}{{D}_{neu}^{IM} + Δ D}$$

The current scale sₙₑᵤ is the scale of the parameter vector p calculated in this image cycle in step d). The previous scale sₐₗₜ is the scale of the parameter vector pₐₗₜ or pₜ₋ₖ calculated in the previous image cycle in step d). The current inertial range estimation D^{IM}ₙₑᵤ is the inertial range estimation received in this image cycle. The previous inertial range estimation D^{IM}ₐₗₜ is the inertial range estimation received in the previous image cycle. Dₐₗₜ denotes the previous actual range to the target and Dₙₑᵤ denotes the current actual range to the target.

Based on this, the range correction ΔD is calculated, which precisely corrects the “incorrect” ranges (=inertial measurements) D^{IM} integrated from inertial measurements, as follows:

$$Δ D = \frac{{s}_{n e u} {D}_{n e u}^{IM} - {s}_{a l t} {D}_{a l t}^{IM}}{{s}_{a l t} - {s}_{n e u}}$$

Using the calculated range correction ΔD, the starting parameter vector p* and in particular the scale s of the starting parameter vector p* is pre-scaled in the next image cycle in step c) using the following formula:

$${s}_{neu} = \frac{{D}_{a l t}^{I M} + Δ D}{{D}_{neu}^{IM} + Δ D} {s}_{a l t}$$

The number of iterations of the Lucas-Kanade method that are necessary to find a sufficiently accurate estimated parameter vector p is thus significantly reduced. By introducing the known scale change, which is as precisely estimated as possible, into the actual tracking method (Lucas-Kanade method) in the course of the pre-scaling, the number of necessary iterations can be significantly reduced. This exact scale change/pre-scaling in turn requires precise range estimation by calculating the range correction ΔD. The scale s estimated in this way is used to correct the inertial-based range estimation D^{IM} in the subsequent image cycle, which leads to substantial improvements, in particular in the case of moving targets.

In step f), an interval of size N is also considered and averages over a predefined number M of scales s are also used at the respective interval ends in order to calculate the range correction ΔD. For M=2*k+1 the correction formula for an image at the point in time t is:

$$Δ {D}_{t} = \frac{( 1 \text{/} M {\sum }_{i = - k}^{k} {s}_{t - N + k + i} ) * {D}_{t - N + k}^{IM} - ( 1 \text{/} M {\sum }_{i = - k}^{k} {s}_{t - k + i} ) * {D}_{t - k}^{IM}}{{s}_{t - N + k} - {s}_{t - k}}$$

In step f), a learning filter is additionally applied in order to further protect the correction value from occasional outliers of individual estimations. For this purpose, the effective correction value at the point in time t is calculated as follows:

ΔD_{eff,t}=(1−α)ΔD_{eff,t-1}+αΔDₜ

where α∈]0,0.5].

The aim of all of the aforementioned measures is to use the correction estimation method as early as possible or as early as is useful in order to reduce the number of iterations of the Lucas-Kanade method as quickly as possible. The specific parameterisation depends largely on the image quality and the image point resolution.

In addition, steps c), e) and f) are carried out only if

$$\frac{{s}_{n e u}}{{s}_{a l t}} - 1 > S ,$$

where S is a predefined threshold value (changes in the scale s become significant). This also contributes to the numerical stability of the method.

In step g), a section, replacing the template T, in the current image data I is selected, in a scale-controlled manner, as a new template T for the next image cycle (resampling), in order to refine the resolution of the target on the template T. In particular, as a function of the scale s, resampling of the template T is repeatedly carried out, which subsequently also renders the scale estimation more reliable. During the mentioned resampling by punching out, the four parameters of the parameter vector p have to be correspondingly reset to

$${p}_{0} = ( \begin{matrix}{x}_{TL , h} \\ {x}_{TL , v} \\ 0 \\ 1\end{matrix} )$$

(as at the start of the method, see above). In addition, the values of the scale buffer (sₐₗₜ) have to be divided by the last calculated scale value s.

In step h), in order to target the missile, in each image cycle of the predefined image cycle rate f_{B}, the missile is controlled in a closed-loop manner based on the improved target point of aim, by a difference with respect to a control point being determined and the missile being navigated/controlled on the basis of this difference. For this purpose, control commands are transmitted to actuating mechanisms of the missile in order to actuate aerodynamic control means (flaps on winglets/wings), and to drives (e.g. jet engine, propeller, etc.) of the missile. The control commands are derived from the estimated parameter vector p.

FIG. 2 shows a schematic representation of a computer-readable medium 20.

A computer program is stored on the computer-readable medium, which program comprises instructions which, when the program is executed by a computer, cause the computer to carry out the steps of the computer-implemented method for (image-based) targeting or flight guidance of missiles according to FIG. 1. By way of example, the computer program is stored on a computer-readable storage disk 20 such as a Compact Disc (CD), Digital Video Disc (DVD), High Definition DVD (HD DVD) or Blu-ray Disc (BD). However, the computer-readable medium can also be a data memory such as a magnetic memory (e.g. magnetic core memory, magnetic tape, magnetic card, magnetic strip, magnetic bubble memory, roll memory, hard disk, floppy disk or removable storage device), an optical memory (e.g. holographic memory, optical tape, Tesa Film tape, LaserDisc, Phasewriter (Phasewriter Dual, PD) or Ultra Density Optical (UDO)), a magneto-optical memory (e.g. MiniDisc or Magneto-Optical Disk (MO-Disk)), a volatile semiconductor/solid-state memory (e.g. Random Access Memory (RAM), Dynamic RAM (DRAM) or Static RAM (SRAM)) or a non-volatile semiconductor/solid-state memory (e.g. Read Only Memory (ROM), Programmable ROM (PROM), Erasable PROM (EPROM), Electrically EPROM (EEPROM), Flash-EEPROM (e.g. USB stick), Ferroelectric RAM (FRAM), Magnetoresistive RAM (MRAM) or Phase-change RAM).

FIG. 3 shows a schematic representation of a data processing device 30.

The data processing device 30 comprises means for executing the computer-implemented method for (image-based) targeting or flight guidance of missiles according to FIG. 1 or for executing the aforementioned computer program. The data processing device (data processing system) 30 may be a personal computer (PC), a laptop, a tablet, a server, a distributed system (e.g. cloud system) and the like. The data processing system 30 comprises a central processing unit (CPU) 31, a memory which has a random access memory (RAM) 32 and a non-volatile memory (MEM, e.g. hard disk) 33, a human-machine interface (human interface device, HID, e.g. keyboard, mouse, touchscreen, etc.) 34 and an output device (MON, e.g. monitor, printer, loudspeaker, etc.) 35. The CPU 31, the RAM 32, the HID 34 and the MON 35 are communicatively connected via a data bus. The RAM 32 and the MEM 33 are communicatively connected via another data bus. The computer program can be loaded into the RAM 32 from the MEM 33 or from another computer-readable medium 20. According to the computer program, the CPU 31 executes steps a) to h) of the computer-implemented method as shown schematically in FIGS. 1 to 8. The execution can be initialised and controlled by a user via the HID 34. The status and/or the result of the executed computer program can be displayed to the user by the MON 35. The result of the executed computer program can be permanently stored on the non-volatile MEM 33 or another computer-readable medium 20.

In particular, the CPU and the RAM 33 for executing the computer program can comprise a plurality of CPUs 31 and a plurality of RAMs 33, for example in a computer cluster or in a cloud system. The HID 34 and the MON 35 for controlling the execution of the computer program can be comprised by another data processing system, such as a terminal, which is communicatively connected to the data processing system 30 (e.g. cloud system).

FIG. 4 is a schematic side view of a missile 40.

The missile is here, by way of example, a rocket 40, which comprises the data processing device 30 according to FIG. 3, a plurality of winglets 41 having flaps, a plurality of wings 42 having flaps, a plurality of drives 43 (e.g. jet engine, propeller, etc.) and an IR camera 44. The data processing device 30 is communicatively connected to the winglets 41, wings 42 and drives 43, such that, in each image cycle of the predefined image cycle rate f_{B}, said winglets, wings and drives are controlled in a closed-loop manner based on the control commands of the data processing device 30 for targeting the missile. The IR camera 44 is communicatively connected to the data processing device 30 and sends image data I during the flight of the rocket 40 at the predefined image cycle rate f_{B} to the data processing device 30. At the predefined image cycle rate f_{B}, the inertial range estimations D^{IM} can be determined and transmitted/provided by a separate device (not shown) that is communicatively connected to the data processing device 30, or by the data processing device 30 itself during the flight of the missile.

As already described above, the difference with respect to the control point of the rocket 40 is determined and, on the basis of this difference, the rocket 40 is navigated/controlled by the control commands, which are derived from the estimated parameter vector p, being transmitted to actuating mechanisms of the rocket 40 in order to actuate the flaps of the winglets 41 and of the wings 42, and to the drives 43.

In the preceding detailed description, various features have been summarised in one or more examples in order to improve the cogency of the presentation. It should be clear, however, that the above description is merely illustrative and in no way restrictive in nature. It serves to cover all alternatives, modifications, and equivalents of the various features and embodiments. Many other examples will be immediately and directly apparent to a person skilled in the art on the basis of his technical knowledge in view of the above description.

The embodiments were selected and described in order to be able to present the principles on which the invention is based and their possible applications in practice as effectively as possible. This enables persons skilled in the art to optimally modify and use the invention and its various embodiments with regard to the intended use.

In the claims and the description, the terms “including” and “having” are used as neutral terms for the corresponding term “comprising”. Furthermore, the use of the terms “a” and “an” should not fundamentally exclude a plurality of features and components described in this way.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding German application No. 102020001234.5, filed Feb. 25, 2020, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

### LIST OF REFERENCE SIGNS

10 computer-implemented method
20 computer-readable medium
30 data processing device (data processing system)
31 CPU
32 RAM
33 MEM
34 HID
35 MON
40 rocket
41 winglets
42 wings
43 drives
44 IR camera

1. Computer-implemented method (10) for targeting missiles, comprising the steps of:
a) receiving, once and prior to the departure of a missile (40), a template T including a target point of aim;
b) repeatedly receiving, during the flight of the missile (40) and at a predefined image cycle rate f_{B}, image data I from a camera (44) of the missile (40) and inertial range estimations D^{IM}ₙₑᵤ from an inertial measurement;
c) per image cycle of the predefined image cycle rate f_{B}, calculating a pre-scaled starting parameter vector p* for this image cycle using a last calculated range correction ΔD;
d) per image cycle of the predefined image cycle rate f_{B}, carrying out an iterative Lucas-Kanade method in order to calculate an estimated parameter vector p, including a current scale sₙₑᵤ based on the current image data I and on the template T, from the calculated pre-scaled starting parameter vector p* by means of mapping Wₚ, wherein the target point of aim is improved by means of the mapping Wₚ using the estimated parameter vector p;
f) per image cycle of the predefined image cycle rate f_{B}, calculating a range correction ΔD for the next image cycle from a current scale sₙₑᵤ, a previous scale sₐₗₜ, a current inertial range estimation D^{IM}ₙₑᵤ and a previous inertial range estimation D^{IM}ₐₗₜ; and
h) per image cycle of the predefined image cycle rate, controlling the missile (40) in a closed-loop manner in order to target the missile (40) based on the improved target point of aim.

2. Method (10) according to claim 1, further comprising the step of:
e) per image cycle of the predefined image cycle rate f_{B}, compensating, by means of an offset and optionally a scaling factor for the next image cycle, for differences in brightness between the template T and the image data I scaled using the mapping Wₚ.

3. Method (10) according to claim 1, wherein steps f) and c) and/or e) are carried out only when changes in the scale s become significant, in particular when
$$\frac{{s}_{n e u}}{{s}_{a l t}} - 1 > S ,$$
where S is a predefined threshold value.

4. Method (10) according to claim 1, further comprising the step of:
g) selecting, in a scale-controlled manner, a section, replacing the template T, in the current image data I as a new template T for the next image cycle.

5. Method (10) according to claim 1, wherein in step f) an interval of size N is considered and averages over a predefined number M of scales s are used at the respective interval ends to calculate the range correction ΔD.

6. Method (10) according to claim 1, wherein a learning filter is additionally applied in step f).

7. Computer program, comprising instructions which, when the program is executed by a computer, cause the computer to carry out the steps of the method (10) according to claim 1.

8. Computer-readable medium (20) on which the computer program according to claim 7 is stored.

9. Data processing device (30), comprising means (31, 32) for executing the method (10) according to claim 1.

10. Missile (40), comprising:
a camera (44); and
a data processing device (30) according to claim 9,
wherein the camera (44) is communicatively connected to the data processing device (30) and is designed to repeatedly send image data I to the data processing device (30) at the predefined image cycle rate f_{B}.
